(19) United States
(12) Patent Application Publication
(10) Pub. No.: US 2010/0114887 A1
(43) Pub. Date: May 6, 2010

(54) Textual Disambiguation Using Social Connections

(75) Inventors: David P. Conway, Los Altos, CA (US); Andy Rubin, Los Altos Hills, CA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/253,791

(22) Filed: Oct. 17, 2008

(51) Int. Cl. G06F 7/06; G06F 17/30

(52) U.S. Cl. 707/737; 707/E17.014

(57) ABSTRACT

The subject matter of this specification can be embodied in, among other things, a computer-implemented method that includes receiving a request to provide a dictionary for a computing device associated with a user; identifying word usage information for members of a social network for the user; and generating, with the word usage information for members of the social network, a dictionary for the user.

### TECHNICAL FIELD

This document describes systems and techniques for disambiguating text entered by a user of a computing device.

### BACKGROUND

People spend a lot of their time entering text into computing devices, whether typing e-mails, submitting search queries, filling out electronic forms, or otherwise. Certain techniques have been developed to assist in such text entry in certain situations. For example, systems can make educated guesses after a user has typed several characters, to suggest possible auto-complete text entries so that the user need not type every character in a lengthy entry. Also, mobile devices often have constrained keyboards so that multiple characters are represented by each key—after a user has pressed several keys, a system can make inferences regarding which letter on each key the user intended to type. In this manner, such a system can select an appropriate word or group of words from key presses that could otherwise be ambiguous.

Disambiguation of input, whether in the form of automatic completion for characters already entered, determination of appropriate characters when each key press could represent multiple characters, or a combination of the two, often relies on dictionaries. In particular, a dictionary in this context may include a number of textual terms and/or phrases, along with indications regarding the frequency with which the terms or phrases appear in typical written language. The most frequently used terms may be given precedence over other terms when suggesting or selecting terms in response to ambiguous user inputs. For example, if a user enters B and A, the user may intend to type BALL or BASEBALL, or a number of other terms. If a dictionary on the user's computing device indicates that BALL is a more popular term than is BASEBALL, then BALL may be provided as the default term that is entered if the user stops typing after two characters. In a similar manner, if a user presses the 2 key on a telephone keypad twice, the user may again be trying to type BALL, BASEBALL, or even ACT, ACTION, ABDICATE, and other such terms. The popularity of each term in the dictionary may control which of the many possible terms are suggested to or selected for the user.

### SUMMARY

This document describes systems and techniques for disambiguating textual input provided by a user to a computing device, such as a desktop computer or smart phone. In general, a social network for the user is analyzed, and the popularity of terms among users of that social network is used to generate dictionary data for disambiguating text entered by the user. The theory is that a user is more likely to use terms that their friends often use. For example, if a teenager has identified various users as friends on a social networking web site, the content of those friends' pages and other similar content may be analyzed in determining popularity of terms for the user. Such a user, for example, may be much more likely to use certain forms of slang in their communication—something that would not be picked up by a dictionary that is premised on more general usage of terms across a wider population.

In a first general aspect, a computer-implemented method is described. The method comprises receiving a request to provide a dictionary for a computing device associated with a user; identifying word usage information for members of a social network for the user; and generating, with the word usage information for members of the social network, a dictionary for the user.

In a second general aspect, a recordable storage medium having recorded and stored instructions thereon that, when executed, perform actions is described. The recordable storage medium includes receiving a request to provide a dictionary for a computing device associated with a user; identifying word usage information for members of a social network for the user; and generating, with the word usage information for members of the social network, a dictionary for the user.

In a third general aspect, a computer-implemented textual disambiguation system is described. The system includes a social network interface for producing data reflecting word usage by members of a social network associated with a user; a dictionary builder programmed to use the data reflecting word usage of the members of the social network to produce dictionary data formatted for use in disambiguating text input by the user; and a prediction module programmed to use the dictionary data to disambiguate text entered by the user.

In still another general aspect, a computer-implemented system is described. The system includes a social network interface to produce data reflecting word usage by members of a user's social network, using an identifier for the user; memory storing master dictionary data that reflects general word usage that is not specific to the user; and means for processing the usage data into dictionary data for use with the master dictionary to disambiguate textual input by the user.

The details of one or more embodiments are set forth in the accompanying drawings and the description below. Other features, objects, and advantages will be apparent from the description and drawings, and from the claims.

### DESCRIPTION OF DRAWINGS

FIG. 1 is a schematic diagram showing a manner in which social connections in a social network can be used to generate dictionary data for input disambiguation using word usage information.

FIGS. 2A and 2B are flowcharts showing example processes for updating a user dictionary using social networking data.

FIGS. 3A and 3B are sequence diagrams depicting examples of interactions between clients and servers.

FIG. 4A is a schematic diagram of a system for updating a dictionary to disambiguate user input.

FIG. 4B is a schematic diagram of a system that provides disambiguation to users entering data on computing devices.

FIG. 5 is a schematic representation of an exemplary mobile device that implements embodiments of the automatic cropping described herein.

FIG. 6 is a block diagram illustrating the internal architecture of the device of FIG. 5.

FIG. 7 is a block diagram illustrating exemplary components of the operating system used by the device of FIG. 3.

FIG. 8 is a block diagram illustrating exemplary processes implemented by the operating system kernel of FIG. 5.

FIG. 9 shows an example of a computer device and a mobile computer device that can be used to implement the techniques described here.

Like reference symbols in the various drawings indicate like elements.

### DETAILED DESCRIPTION

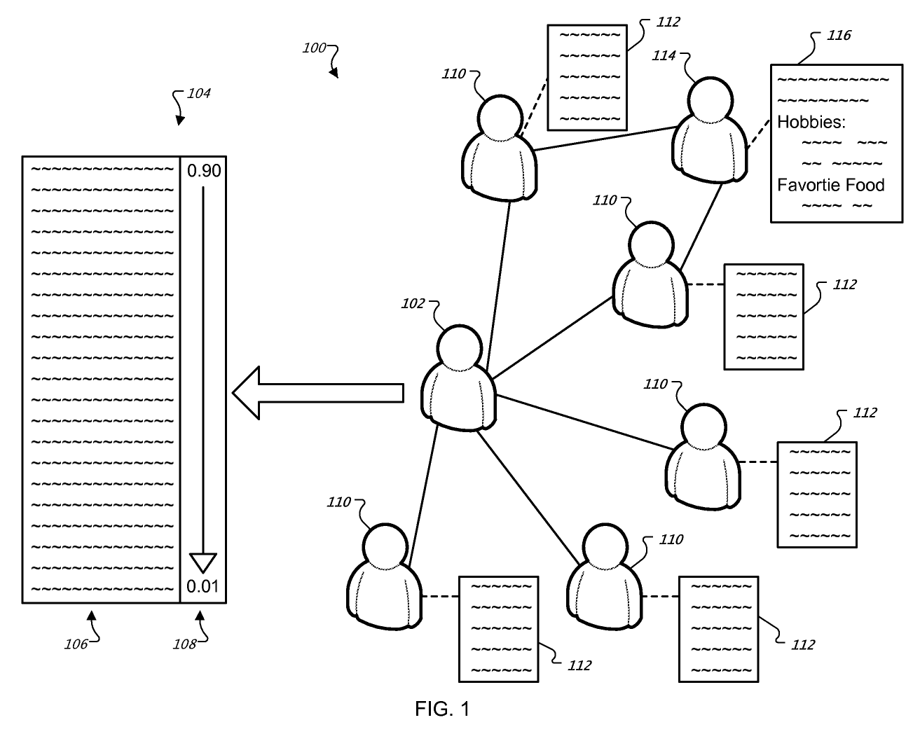

FIG. 1 is a schematic diagram showing a manner in which social connections in a social network can be used to generate dictionary data for input disambiguation using word usage information. The figure shows a system 100 in which a number of different users 102, 110, 114 are connected as friends and friends-of-friends in a social network, as personal associations through a web site. Each member of the social network may have various forms of textual content associated with them, such as pages 112 on which they post information, profile pages 116 where they list relevant features about themselves, and other content such as discussion pages or text message logs of communications between the various members. Each of these sources may reflect typical usage by members of the group, and may thus reflect usage that a member of the group is likely to employ in the future. As a result, the sources may be used in various manners, such as those described in more detail below, to provide dictionary data for use by a computing device in suggesting terms or phrase for a user.

Referring more specifically to FIG. 1, a user 102 is shown as being associated with a dictionary 104 that contains multiple entries 106. The entries may be particular words or phrases, or may take other appropriate forms. Each word represents a word that the system 100 has judged to be a word that the user 102 might employ in the future. In this example, the words are shown sorted from most common at the top to least common at the bottom, with a normalized scale from 0.01 to 0.90. In general, terms in a disambiguation dictionary would instead be sorted in a tree structure, with each node stepping down through the tree representing each successive character in a word, or each key from a keypad. Each term may then have word usage information (e.g., a weighting at its respective position in the tree). For example, a tree structure for a typical telephone keypad could have eight branches emanating from a root node (because letters are displayed on keys 2-9, though one or more additional branches may be included for non-alphabetic characters), and another eight branches at each node at the next level. Thus, the tree may be traversed as a user presses keys on the keypad, so as to prune away impossible solutions. Other appropriate mechanisms can also be used for arranging words or phrases, and for indicating their likelihood of use. The particular arrangement of the dictionary 104 is generally not critical.

Although each word has a single score in this example, for clarity, more complex scoring techniques may also be used. For example, a term may have scores that are context dependent so that the score for “day” is higher if the user just typed “sunny” than if the user 102 typed another word.

The scores associated with each word generally represent predicted popularity of a word or phrase, in terms of how likely it is that the user 102 will enter the word or phrase in the future. Such data may, in general systems, be taken by analyzing a large corpus of documents, such as a number of books or e-mails across an entire company, identifying the frequency with which various words are used in that corpus, and ranking the words in a normalized manner based on their frequency of occurrence. Such scores may then be adjusted by looking at documents specific to the user 102, such as e-mails in the user's 102 outbox and/or inbox, documents stored on a computing device for the user 102, or documents stored on a server in a user account associated with the user 102.

In this example, the ranking of each term (e.g., word or phrase) may alternatively associated with connections in a social network. The pictured example, the user 102 is shown as having two degrees of connections in their social network. The user's 102 first degree connections 110 are shown as having documents 112 that are associated with them. The user 102 is also shown as having a second degree connection with a user 114 who has one or more associated documents 116.

The documents 112, 116 may take a variety of forms, and may include, for example, typical profile pages on a social networking site such as ORKUT, MYSPACE, or FACEBOOK. Other pages may also be included, such as additional pages that a user submits that are adjunct to their profile page. In addition, other communications by users 110, 114 may be checked, such as transcripts of text message sessions between and among the users 102, 110, 114. Thus, for example, the system 100 may analyze the various documents 112, 116 to determine a frequency of usage of words and phrases in the documents 112, 116. If the users are teenagers, the analysis may identify many phrases that would not have appeared in a review of standard English usage, such as OMG (“Oh my God!”), “like,” “totally,” “sick” and other such slang terms.

The system 100 may also or alternatively analyze dictionaries associated with each of the users 110, 116. The dictionaries may be stored on client devices associated with each of the users 102, 110, 114, and copies of the dictionaries may be stored on a central server, which may include one or more server devices. The social connections between various users may be used in a variety of ways to influence the scores for words in dictionary 104. As one example, the system 100 may analyze all or some of the documents 112, 116 in a social network and create a frequency distribution for words or phrases in the documents. The words may then be weighted according to their location in the system. For example, a word in a profile page, such as one indicating that a user's favorite food is blueberries could receive a lower weight or a downwardly adjusted score relative to a word in an outgoing text message because the a user 110 is presumably much more likely to user the latter term in a communication session in the future than the former term—by extension, user 102 would also presumably be more likely to use the term, under the presumption that friends use similar words and phrases when communicating.

Also, the contribution of users 110 in the first level of the social network for user 102 may be weighted more heavily than the contributions of more distant users such as user 114. In one example, a recursive approach may be used whereby scores for words in each user's dictionary are averaged with scores for their next adjacent neighbors in the social network. Thus, for example, in a first iteration, scores from user 114 may be passed partially to dictionaries for the two top users 110 in the figure, and parts of those scores may then be passed indirectly in a next cycle to dictionary 104. Each user's score may also be artificially weighted so as to anchor their ultimate score somewhat to their original score so that, after a large number of iterations, all of the users do not have identical dictionaries. In this manner dictionary 104 can most strongly reflect the actual usage of user 102, and less so the usage of users 110, and even less so the usage of user 114. In particular implementations, then, the weight of a particular user's usage may fall away exponentially or in a similar manner with the distance away from a central user in the social network.

In addition, the scoring provided from usage by user 102 and users 110, 114 may be blended with other more traditional scoring techniques. For example, a typical dictionary that is generated from a large corpus of public documents may be used as a basis for scoring, and may then be combined with usage data for user 102, and also usage data from users 110, 114. Other combinations of signals for ranking words and phrases in a dictionary such as dictionary 104 may also be employed.

Once the new entries and values have been integrated into the user's 102 dictionary 104 from the social network, the dictionary 104 may be used to provide disambiguation for text entered by the user. Disambiguation can provide alternative choices to the user 102 based on the user's 102 input. For example, a user who has entered 2-2-7 may intend to complete the word “Carla” or “baseball.” The entries in the dictionary may be organized hierarchically according to their characters, so that as the user types, solutions corresponding to keys the user has not pressed may be pruned out of the potential solution set. The remaining candidate solutions may then be presented to the user, ordered according to their scores in the dictionary 104. Such disambiguation can occur both for constrained keyboards, where the system is required to infer what the user intended by keys that have already been pressed, and for text entry completion, where the system needs to extrapolate from entries that have already been made (where the entries may be definite (e.g., if the user has a full keyboard) or ambiguous). As the user continues to press keys, the set of possible solutions can be further pruned and narrowed down, with suggested solutions updated after each key press, in a familiar manner.

In some implementations, the user 102 can signal to her device that she does not want a particular word displayed. Conversely, she can select a word from a list that is displayed in a drop down below a text entry box, and her device may then complete the entry using the selected word.

If the user 102 picks one word over another, such a selection can affect the value of both entries in the dictionary 104. In some embodiments, one entry (the selected entry) can increase its associated value. Likewise, the other entry can decrease its associated value. Such user 102 decisions can also have no effect on the values associated with multiple entries 106 in the dictionary 104.

The ranking of terms in a dictionary may rely on social networking-based mechanisms other than, or in addition to, those discussed above. For example, the process of associating values with terms in a dictionary may occur by determining the popularity of a member, or the number of connections between a particular member and other members. For example, if Tila Tequila, one of the most popular members of MYSPACE, with over 2 million first degree connections, has “MTV” associated with a high value in her dictionary, those linked to her can have “MTV” associated with a higher value than if a friend with 20 first connections has “MTV” associated with the same value.

Likewise, the value associated with an entry can depend on the degree of connection with a user 102. For example, if a user 102 has an entry in common with a first degree connection 110, the value associated with that word can increase more than if the user 102 has the entry in common with a second degree connection 114. Similarly, the commonalties between users, such as shared groups, networks, schools, and music or video entered in the user's 102 profile and connection's profile can determine the increase in value associated with a shared word in their respective dictionaries. In other implementations, increases in values associated with words in dictionaries can depend on the amount of contact that members have within the social network. For example, if a member reads and comments on a blog for one of their friends or connections, or writes on the connection's wall, there can be an increase in the value associated with the words in the connection's dictionary in the user's dictionary.

A user 102 can be permitted to delete or alter terms from her dictionary 104 manually. In some implementations, the user can access the dictionary and change the values for an entry. For example, if the user 102 does not like “Grey's Anatomy”, she can change to a lowest setting the value of a term relating to that show that appears in her dictionary only because a number of members in her social network have many references to the term in their social networking pages.

Dictionaries can also be shared. For example, a corporation may maintain a common dictionary that is built using data from pages from employees of the corporation. Such a shared dictionary may thus provide employees with ready access to textual disambiguation that takes into account peculiar constructions of the company, such as particular acronyms or names of people in the corporation. Alternatively, dictionaries may be created for particular social networks and provided for text-entry disambiguation to each member of the network, where the initial dictionary may be modified somewhat to better reflect an individual's usage within the group.

The user 102 can also have multiple dictionaries. For example, the user can have a public dictionary, so that all dictionaries in the social network can affect and be affected by her public dictionary, a private dictionary, and a semi-private dictionary (e.g., that can be accessed only by first-level friends). The user 102 may also have application-specific dictionaries. For example, when a user is typing e-mails, they may be much more likely to type terms such as LOL or OMG, so such terms may have higher ratings when the user 102 is using e-mail. In contrast, the user may never use such terms when conducting search, so that a more global (not user-specific) dictionary may be used in such a situation, such as a dictionary that takes into account recent search activity directed at a particular search engine so that a user is likely to see, at the top of a list of suggested terms, the terms that have been popular search terms with other users recently.

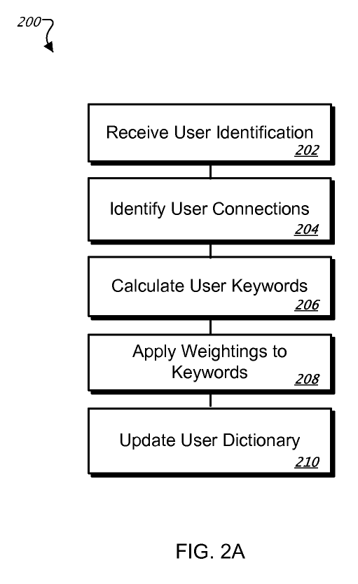

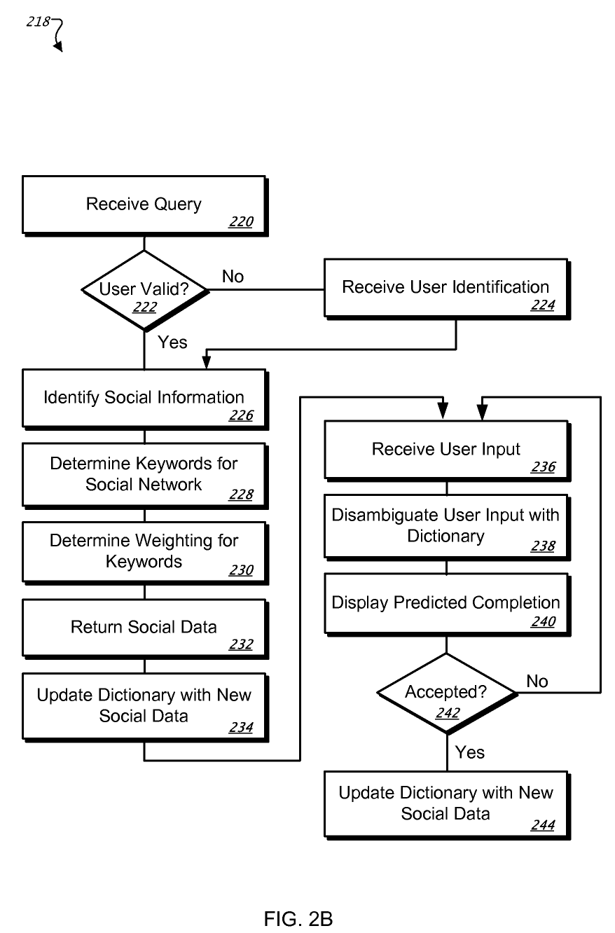

FIG. 2A is a flowchart that shows an example of a process 200 for updating a user dictionary using social networking data. The process 200 generally involves receiving a user's identification, identifying the user's social connections, calculating the user's keywords, applying weightings to terms, and updating a dictionary belonging to the user. In general, the process 200 involves determining social connections for a user, identifying words that are used by the user and members of their social network, applying weightings to the words based on the frequency with which the user and the members of their social network use the words, and updating the user's disambiguation dictionary accordingly.

At an initial step, the process 200 receives (202) a user's identification. For example, the user can sign into a social networking site to send her identification to a server. The identification may be obtained in a variety of ways, such as by obtaining identifying information from a cookie on the user's computing device, by having the user provide a user name and password, or by other known mechanisms

The process 200 then identifies the user's social connections. For example, a social networking server can store data regarding who has a first degree connection with the user, such as a “friends” list. The social networking server can also store data regarding links that the user has in common with other social networking members, such as members who are classmates with the user, members sharing common interests with the user, or members who are otherwise in a common group or groups with the user.

The process 200 then calculates (206) the user's keywords. Such keywords may be words or phrases that appear in the user's content (e.g., e-mails or text messages sent or received by the user, web pages such as social network profile pages for the user, etc.) or other words or phrases that can be associated with the user such as content on pages or communications for the user's social network. For example, the user's friends can each have their own keywords. After the user's friends are identified, each friend's keywords can be determined and compared to the user's keywords. In some implementations, the friends' keywords can be compared to each other to determine if there are multiple friends with the same keyword before determining if the user also has the same keyword.

Weightings are then applied to the user's keywords (208), though the weightings may be applied as part of the process of identifying the keywords. In one example, each user may start with a default dictionary, which may simply be a general group dictionary, such as a dictionary meant to apply to all English speakers generally. For example, the default dictionary may be produced by analyzing the frequency of use of words in a large corpus of public documents, or in document from a particular organization. The words in this default dictionary may be the top X occurring words in the corpus (where X may be determined by the space available to store the dictionary), with weightings reflecting their relative frequency of occurrence in the corpus. As noted above, weightings may also reflect the frequency of occurrence of words in combination with other words. Particular documents for a user (e.g., text messages, e-mails, and web pages) may then be analyzed, and the words in those documents may be added to the default dictionary and/or change the weightings of the words in the default dictionary. The weightings created by the presence of words in the user's personal files may be much larger than for those from general usage, since the user can be presumed to repeat some of her earlier usage patterns. The weightings may then be further refined by looking to dictionaries of other users in the first user's social network, such as in the manners described above, so that the first user's usage has the highest impact on a word's score, and friends' usage has a lesser effect that drops further as one moves away from the user in the social network. In some implementations, the weightings can be compared against a standard language dictionary. For example, if the user's social network has instances of spelling the word “their” as “thier,” the weighting against a standard English dictionary can be refined based on the lack of the word “their” in the English dictionary.

At box 210, a dictionary belonging to the user is updated. Such updating may involve adding new keywords obtained from sources such as a search engine (i.e., providing terms that have been used recently in search queries), and also changing weightings for new or previously existing words in the dictionary

A user's dictionary may also be updated periodically or continuously. For example, each time the user types a text message or submits a search query, the terms in the submission may be added to the user's dictionary, or the terms' ratings can be increased dramatically, under an assumption that the user is likely to repeat the terms again soon. Also, a system may access dictionary data for others in a social network on a scheduled basis (e.g., each night) and may update dictionaries for all users in the network. Such updated dictionary data may be stored with the system, and in systems in which the dictionary is also, or alternatively, stored on remote devices, the dictionary data may be synchronized the next time the user logs on with their remote device.

In this manner, process 200 provides one example by which a disambiguation dictionary may be made personalized for a user by taking into account data on members of the user's social network. Such data may be particularly useful because it is much more specific to the user than is general usage data for a large population, and it is more voluminous than usage data for the user alone. As a result, it may provide, in effect, a predictive update to the user's dictionary so that the data is already in the dictionary when the user picks up cues from her friends and starts using new words they have already been using.

FIG. 2B is a flowchart showing an example of a process 218 for updating a user dictionary with social networking data. The process 218 shows one example for providing predictive textual completion for a user who is entering a search query into a computing device. The predictive information shown to the user is selected based, in part, on word usage by members of the user's social network.

At an initial step, the process 218 receives (220) a query. For example, a user can submit a query to a search engine such as a general web search engine or a specialized search engine, such as a search tool for a social networking web site. Such a submission, or another submission, may indicate to a system that the user wishes (either explicitly or implicitly) to be provided with data that improves the accuracy of textual disambiguation for text entered on the user's computing device.

The process 218 then determines (222) if the user is valid. In other words, a system may store information for a number of members, and the process 218 may verify that the user is such a member. For example, the user can send her password to a social networking server or other form of server, such as by manually logging onto a site, or by her computer automatically sending information to a server, such as from a cookie or other similar mechanism.

Once the process 218 confirms that the user is valid, the process 218 identifies (226) social information associated with the user. For example, a server system can store social information specific to the user, such as the user's profile, the user's dictionary, the user's blog, the user's social connections, and the user's groups. The social information can be stored together on one social networking server or can be stored across multiple servers. In other implementations, some or all of the social information can be stored on the user's device, and copies can be stored between the user's device and the server system and synchronized between the user's device and the server system.

With social information about the user identified, the process 218 determines (228) keywords for the social network. For example, the social networking server can retrieve words from documents (e.g., web pages, e-mails, or text messages) corresponding to people who are socially connected to the user. Such keywords may be added to the user's dictionary if they are not already present in the dictionary.

After the list of keywords is compiled, the process 218 determines (230) weightings associated with each of the keywords (and can also change weightings applied to terms already in a dictionary), though the weightings may occur at the same time as identifying keywords. Numerical values can be assigned to the keywords, for example. As described in more detail above, various implementations may be used to determine the values associated with each keyword.

The process 218 then returns (232) data relating to the classification of terms for a dictionary, such as by identifying keywords and associated weighting values for use with a user dictionary. The process 218 then updates (234) the dictionary with the new social data. For example, the server can compile the user's dictionary using the new data computed using the user's social connections.

Once the user's dictionary has been compiled, the process 218 receives (236) user input that is subsequent to the original input that triggered the updating of the dictionary. For example, the user can input numbers intending to have the input disambiguated. If the user enters 2-2-7 on a numeric keypad, the application can assign letters to each number, such as A, B, or C to the number 2 on a numeric keypad. The user can also input letters using a QWERTY keyboard. Likewise, the user can input letters with a stylus in a program that can determine the letter based on the shape entered by the stylus. In another embodiment discussed further below, the application can use spoken words as user input.

The process 218 then disambiguates (238) the user input with the dictionary. The disambiguation may occur, for example, by identifying all candidate terms in a dictionary that could match the entry by the user, and then by ranking each potential candidate. Such disambiguation can be updated in familiar manners each time the user enters a new character.

The disambiguation can occur in different devices. For example, a disambiguation server can disambiguate the input using the dictionary, and may transmit updated information to the user's computing device so that a list of suggested words appears quickly for the user. The disambiguation can also occur locally on the user's computing device, which may make response time faster but may also limit the size of the dictionary in some circumstances. Certain parts of the disambiguation may occur locally on the user's device and certain may occur on a server also. For example, the user's device may track words that the user entered into her device recently (and may retire those words after a predetermined time period), and may provide such words at the top of a drop down list of suggested word completions, whereas the reminder of the words in the list may be provided using a disambiguation dictionary at a server.

At box 240, the process 218 can display the predicted completion. For example, as noted, the application can display a listing of keywords from the user's dictionary in order of their associated value, with the display just above or below the area in which the user is currently typing. In other embodiments, the application can display the keyword with the highest associated value, displayed right over a textbox where the user is currently typing.

In step 242, the process 218 determines if the suggested completion has been accepted 242 by the user. For example, the user can explicitly accept the suggested completion (e.g., by pressing enter or clicking on a mouse button. In other implementations, accepting the suggested completion can be implicit, such as by the user typing a space to indicate that they have finished typing a particular word.

If the user does not wish to accept the suggested completion, the user can simply keep typing and ignore all of the suggestions. The user can also press a delete key to back up one character in their typing, and to have displayed the suggested solutions for that new shorter string of entered characters. In a situation in which the user does not wish to accept the suggested completion, the process 218 can return to step 236 until the user accepts a new suggested completion or enters a word that does not match any keywords in the dictionary.

Once a user accepts a predicted or suggested completion or enters a new word, the process 218 updates (244) the dictionary with new data. For example, an accepted predicted completion can increase the value associated with a keyword by a constant. For example, the relative weighting for a term that the user selects can be increased in the user's dictionary and/or the selected term can be added to a separate group of terms that the user has entered recently, where that group may be placed at the top of any later list of suggested completions. Such a list may be associated with a time decay, so that terms used by a user disappear from the top of the list if the user uses them once and then never again.

In one implementation, the user can use spoken words to input data to the user device. Disambiguation can aid the application in determining which words the user associates with individual sounds. The user can accept predicted completions implicitly by continuing to enter spoken data into their device. The user can also accept predicted completions explicitly through vocal commands such as “yes” or “correct”. In other embodiments, the user can also accept words through non-verbal means, such as by keypad or mouse actions.

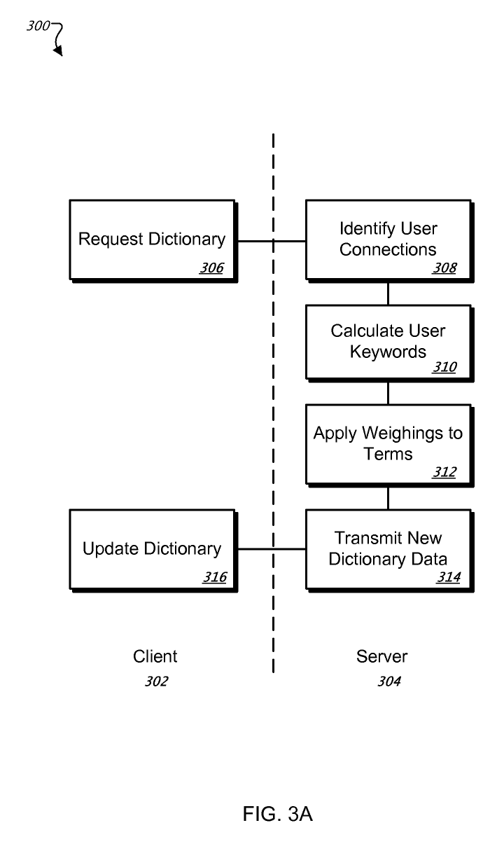

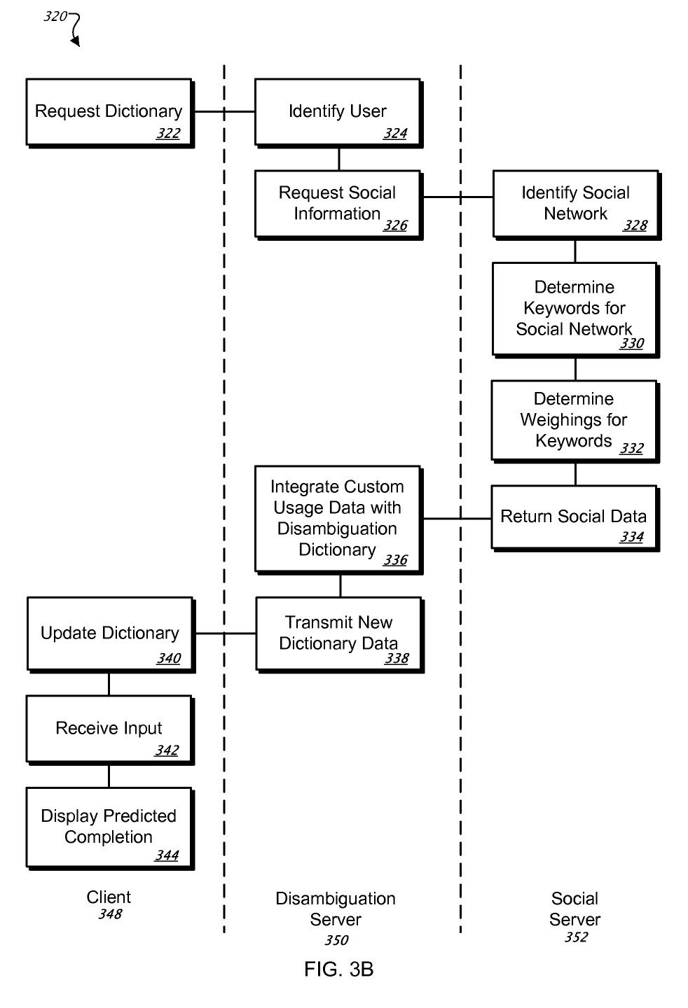

FIG. 3A is a sequence diagram depicting an example of interactions 300 between a client 302 and a server 304. The process shown here is similar to that shown in FIG. 2A, and provides a more explicit showing of exemplary manners in which a client and server system can interact in providing disambiguation information to a computer user, and can update such information using word usage by members of a social network to which the user belongs. In general, the interactions involve a client requesting dictionary information from a server, a server retrieving such information based on a user's connections within a social network, and the server providing updates to the client for the dictionary. The client can use the updated dictionary to improve word completion disambiguation.

In the figure, the client 302 initially transmits a request to access a dictionary (box 306), such as a user's personal dictionary, to the server 304. The server 304 then identifies the user's connections (box 308) in a social network and calculates user keywords 310 based on those connections. In some implementations, the server 304 can determine keywords for people who are socially connected to the user by performing searches through each person's data. For example, a member of a social network can have a profile, and the server 304 can analyze sort through text or other data in the profile to determine keywords.

The server 304 then applies weightings to terms (box 312) based on the keywords, generates a new dictionary or additional dictionary data, and transmits the new dictionary data 314 to the client.

The server 304 can determine the keywords and apply weightings to each keyword (box 312) using various factors. For example, the server 304 can apply weightings to terms based on the degree of separation between a user and a member of the user's social network from which a word has been obtained. The weightings can also or alternatively be based on the number of friends a user has. Likewise, the weightings can be based on similarities between data associated with the user and the friend's data. The weightings can also be based on the number of friends who have the same keyword within their connection data.

The server 304 then takes the weighted terms, formats the information into dictionary data, and transmits the dictionary data (box 314) to the client 302. The client 302 can use the new dictionary data to update the user dictionary (box 316). For example, the client 302 can add the new dictionary data to a pre-existing dictionary that was already stored on the client 302. In some implementations, the new terms can be added to the previous dictionary. In other implementations, the new dictionary data can replace the previous dictionary. In still other embodiments, the client 302 can apply the new weightings from the server 304 to corresponding terms that already existed n the original dictionary. In other embodiments, the dictionary may remain at the server 304, and data may be passed between the client 302 and the server 304 as a user types and is presented with suggested word choices by the client 302.

FIG. 3B is a sequence diagram that depicts an example of interactions 320 between a client 348, a disambiguation server 350 and a social server 352. In this example, particular interactions between different specialized server groups are shown to provide an example for implementing a system that shares social data with a disambiguation engine. In particular, social server 352 may be part of a general social networking system and may communicate with disambiguation server 350 via an application programming interface (API) so that disambiguation server can obtain information about a user's social network and word usage by members of the network, in developing or updating a disambiguation dictionary for the user. In this manner, the disambiguation server 350 may more readily and accurately predict the user's intentions when the user is in the process of entering text into the system.

In the example process, a client 348 initially transmits a request for dictionary data (box 322) to a disambiguation server 350. The disambiguation server 350 identifies a user (box 324) associated with the client 348, such as by information from a cookie stored on the client 348. The disambiguation server 350 then requests social information (box 326) from a social server 352. The disambiguation server 350 may do so as part of a larger process of developing or updating dictionary data to be provided to the user who is using the client 348. For example, the disambiguation server 350 may take into account a number of factors when ranking words or phrases in the disambiguation dictionary, such as usage of words in on line news sources, usage of words in recent search engine queries form the public, and usage by the user herself. Submitting a request to the social server 352 may be yet another mechanism by which to acquire data that may reflect probable future usage by the user of client 348.

The social server 352 then identifies a social network (box 328) for the user of the client 348, determines keywords for the social network 330 such as by analyzing documents associated with members of the user's social network, determines weightings for the keywords (box 332), and returns the social data (box 334) to the disambiguation server 350. The data may take a variety of forms so as to protect the privacy of users of the social network. For example, the returned data may simply include words and associated rating information for the words, so that the disambiguation server 350 cannot determine who used the words, from among the various members of the social network. Also, the social server 352 may keep confidential the identities of the members of the user's social network.

The disambiguation server 350 then integrates custom usage data with a prior disambiguation dictionary 336. For example, the prior dictionary may be a general dictionary that ranks words and phrases based on their general usage in common English. The custom usage data can include various updated information for the dictionary, including data that reflects historical usage by members of the user's social network. After integrating the custom usage data, the disambiguation server 350 transmits the new dictionary data (box 338) to the client 348. In the embodiment shown in the figure, the client 348 updates a dictionary 340, receives input 342 from the user, and displays its predicted completion 344. In this manner, a client device may provide its user with predicted completions of text entry that more closely match the user's own usage, as inferred by the user of people currently entering search queries, as determine by recent events in the news, and as determined by the usage of words and phrases by the user's social circle.

The client 348 can request dictionary data 322 from the disambiguation server automatically. For example, the client 348 can transmit the request whenever a user opens a particular application on the client 348. In another embodiment, a user can send a request to update dictionary data on their computing device. Conversely, the client 348 can send a request for dictionary data on a periodic basis, such as daily, weekly, or monthly.

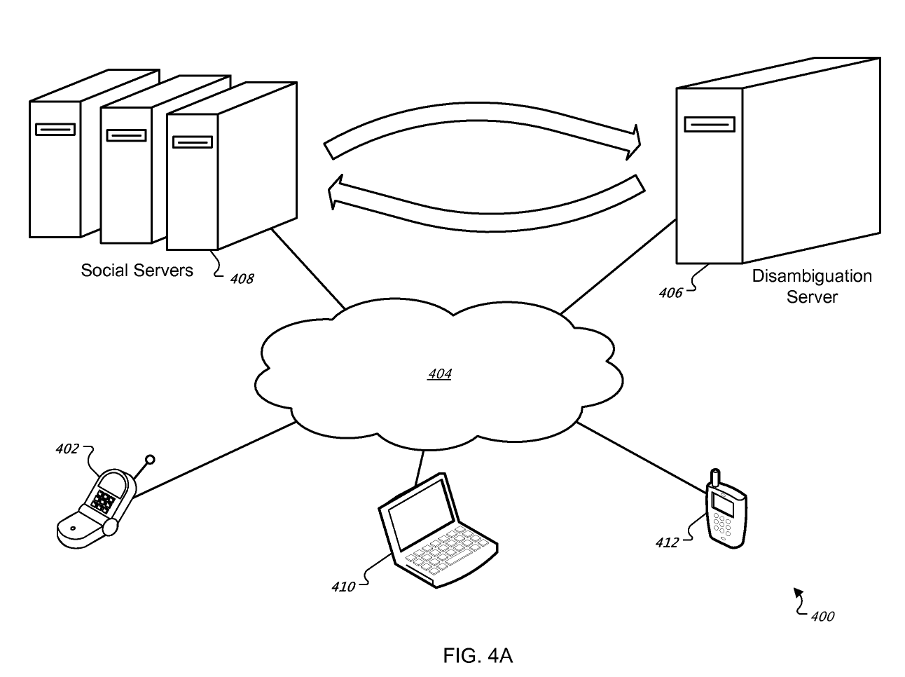

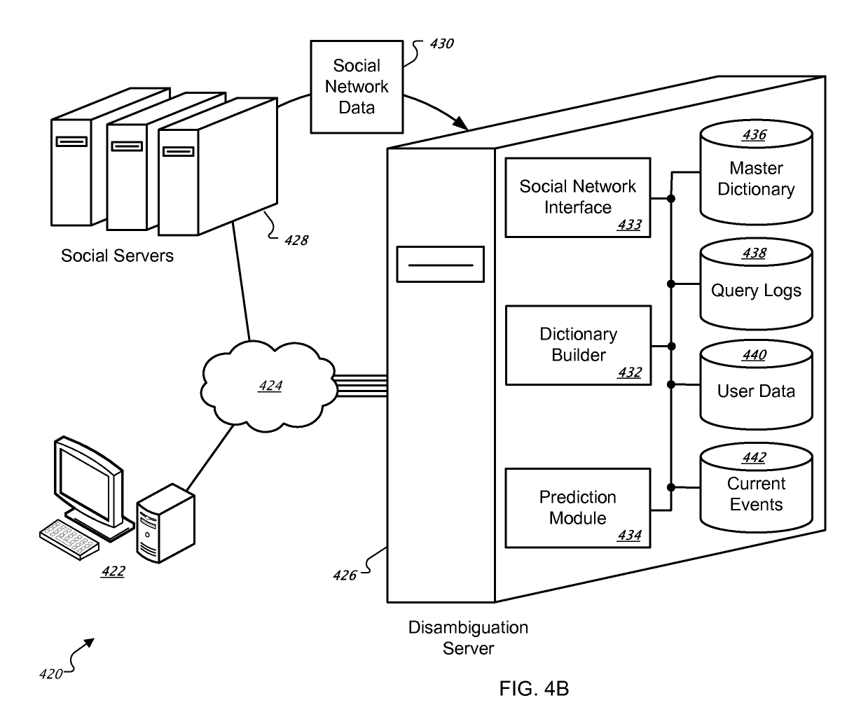

FIG. 4A is a schematic diagram of a system 400 for updating a dictionary to disambiguate user input. In general, the system 400 permits various users who are members of social networks to have information form their social connections used in creating or updating a disambiguation dictionary or dictionaries.

Users can interact with the system by various mechanisms such as cellphone 402, laptop computer 410, and smartphone 412. The cellphone 402 may include a constrained keyboard so that when a user presses a key, the system cannot determine for certain what character the user intends to enter. Such entry may thus benefit from disambiguation. The laptop computer 410 and smartphone 412, in contrast, may have full QWERTY keyboard, but a user's text entry may be ambiguous on them when the user has only entered part of a word or phrase. Disambiguation of the user's text entry in such a situation may be beneficial by completing the word that a user is in the process of entering.

The disambiguation server 406 may help with disambiguating text entered by a user on various remote devices. The server 406, for example, may provide data for disambiguation dictionaries on the devices themselves, or may provide suggested text entry completions over the network 404 as a user types. The disambiguation server 406 may include one or more servers, and may be part of a system such as a search engine, whereby suggestions are displayed with a web page as the user types text such as search queries into the page. In a similar manner, the user may type text into a search box on a toolbar, and the toolbar application may interoperate with the disambiguation server 406 to display suggested answers as the user types.

In this example, the disambiguation engine also communicates with a group of social servers 408, which may be part of the same domain as the disambiguation server 406 or may be from a different domain. As described in detail above, and as shown schematically by arrows between disambiguation server 406 and social servers 408, the disambiguation server may, in the process of generating dictionary data for a user, seek information about the user's social network. For example, the disambiguation dictionary may pass to the social servers 408 an identifier for the user and credentials indicating that the disambiguation dictionary is a legitimate requester of data. The social servers may then perform actions like those discussed above, in identifying words on documents associated with a social network of a user and applying weightings to those words. The social servers 408 may then pass back to the disambiguation server 406 a list of the identified words (with common words like “a”, “the”, “and”, etc. removed) and the weightings associated with those terms. The returned information may then be incorporated into a user's disambiguation dictionary, which may be stored on the disambiguation server 406 and/or one of the devices 402, 410, 412.

FIG. 4B is a schematic diagram of a system 420 that provides disambiguation to users entering data on computing devices. The system 420 is similar to system 400 in FIG. 4A, but more focus is paid to the particular disambiguation server 426 in this example.

Again, the system 420, like system 400, includes remote devices such as computer 422 that can electronically access a number of servers over a network 424 such as the internet. Such services, such as web search services, can be augmented by a service that disambiguates text entry by user so as to make such text entry quick and more error free. In this example, the disambiguation services are provided by a disambiguation server 426.

The server 426 contains a number of components that permit it to provide a user's remote device, such as computer 422, with disambiguation as the user types into the device. For example, a prediction module 434 receives information about what a user is typing and returns data for predicted completions to the user's device. The module 434 may operate by traversing a tree structure where each node in the tree structure is a character entered by the user, and the solutions for text entry are all words in the tree that are below the current node. Also, each entry for a word may include a weighting that determines how the word is displayed, relative to other potential solutions, in a list of predicted entries that may be shown to a user as she types. Such a structure may be stored as one or more dictionaries, such as a master dictionary 436 that reflects word usage across a large body of documents, and may be used as a starting dictionary for users, before their dictionaries are customized as described above. User data 440 may in turn store a number of parameters associated with various users in a system, and may also store custom dictionary data for each user. The custom dictionary data may be used in place of the master dictionary 436, or may be used to augment the master dictionary 436.

Such custom dictionaries may be constructed by a dictionary builder 432. The dictionary builder may rely on a number of different sources in building a custom dictionary for a user, where those sources are selected to reflect words or phrases that the user is likely to type in the near future. In one example, current events data 442, such as recent newspaper and magazine articles can be analyzed to determined the words that are used in the articles, and the frequency with which the words are used. Such “fresh” content presumably reflects the sorts of current events issues that a user is likely to type into their device, such as when conducted searches. Likewise, query logs 438 may be analyzed to identify query terms that users have submitted to a search engine, under the presumption that a user of computer 422 is somewhat likely to repeat entries made by other people, especially if the entry relates to a growing trend.

The dictionary builder may also rely on external data sources, such as social network data 430. In the figure, a social network interface 433 is shown and is programmed to make requests from a group of social servers 428 for information reflecting word usage. The request may follow a common API that may require that the disambiguation server 426 do nothing more than identifier the user and identify itself. The social servers may conduct processing like that discussed above, and may return data relating to the user's social network 430, such as data formatted to be added to a user's disambiguation dictionary, which data reflects usage by the user's social network. Presumably, use by friends is at least somewhat predictive of future word use by the user.

In this manner, system 420 may provide customized text entry assistance to a user. The customization may be directed to temporal information such as recent news stories and search queries, but it may also be aimed socially, so as to provide even more accurate disambiguation than would otherwise be possible.

In some implementations, textual disambiguation may occur using data from the computer 422. For example, the user may have files such as word processing documents, instant messages, movies, contacts, and calendar items stored on the computer 422. Data included in these items may provide further data for the disambiguation server 426 when data is shared between the computer 422 and the disambiguation server 426 (e.g., when the computer 422 syncs with the disambiguation server 426). In one example, if a calendar includes an item, “Samantha's Birthday,” the terms “Samantha's” and “Birthday” may be added to user data 440. Similarly, a user's browsing history may be used as data. For example, if a user's cached data includes espn.com baseball files, the use of the word “baseball” in text, images, or file names may be used by the dictionary builder 432. Data may also be provided from other client devices, such as mobile devices, media players, or other computers.

Likewise, other servers connected to the network 424 may provide further data to user data 440. For example, a user may have an account on a server separate from the disambiguation server 426 or the social servers 428 that stores information, such as an e-mail account or an instant messaging account. The data from the separate server may be synchronized with the disambiguation server's 426 data in user data 440. In some implementations, the user may add accounts on various servers to provide more data to the disambiguation server 426. In one example, the user may link a Yahoo! e-mail account and an AOL instant messenger account to the disambiguation server 426. Data may be provided from multiple sources, including servers and client devices. For example, a mobile device and a user account from a separate server may both provide data to user data 440.

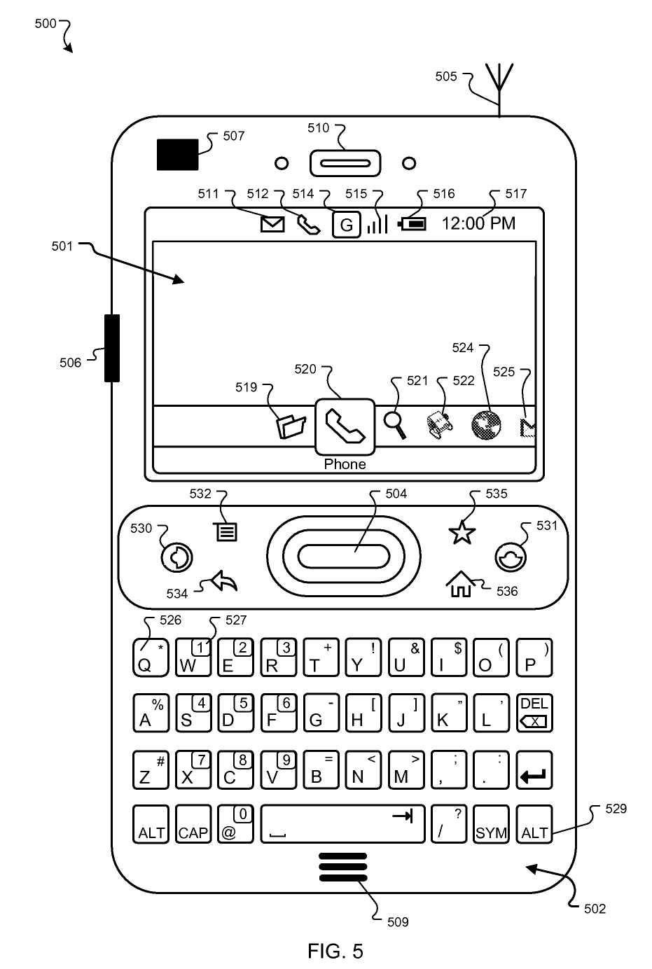

Referring now to FIG. 5, the exterior appearance of an exemplary device 500 that implements a social disambiguation dictionary is illustrated. Briefly, and among other things, the device 500 includes a processor configured to access and update the social disambiguation dictionary upon request of a user of the mobile device.

In more detail, the hardware environment of the device 500 includes a display 501 for displaying text, images, and video to a user; a keyboard 502 for entering text data and user commands into the device 500; a pointing device 504 for pointing, selecting, and adjusting objects displayed on the display 501; an antenna 505; a network connection 506; a camera 507; a microphone 509; and a speaker 510. Although the device 500 shows an external antenna, the device 500 can include an internal antenna, which is not visible to the user.

The display 501 displays video, graphics, images, and text that make up the user interface for the software applications used by the device 500, and the operating system programs used to operate the device 500. Among the possible elements that may be displayed on the display 501 are a new mail indicator 511 that alerts a user to the presence of a new message; an active call indicator 512 that indicates that a telephone call is being received, placed, or is occurring; a data standard indicator 514 that indicates the data standard currently being used by the device 500 to transmit and receive data; a signal strength indicator 515 that indicates a measurement of the strength of a signal received by via the antenna 505, such as by using signal strength bars; a battery life indicator 516 that indicates a measurement of the remaining battery life; or a clock 517 that outputs the current time.

The display 501 may also show application icons representing various applications available to the user, such as a web browser application icon 519, a phone application icon 520, a search application icon 521, a contacts application icon 522, a mapping application icon 524, an email application icon 525, or other application icons. In one example implementation, the display 501 is a quarter video graphics array (QVGA) thin film transistor (TFT) liquid crystal display (LCD), capable of 16-bit or better color.

A user uses the keyboard (or “keypad”) 502 to enter commands and data to operate and control the operating system and applications that provide for the social disambiguation dictionary. The keyboard 502 includes standard keyboard buttons or keys associated with alphanumeric characters, such as keys 526 and 527 that are associated with the alphanumeric characters “Q” and “W” when selected alone, or are associated with the characters “*” and “1” when pressed in combination with key 529. A single key may also be associated with special characters or functions, including unlabeled functions, based upon the state of the operating system or applications invoked by the operating system. For example, when an application calls for the input of a numeric character, a selection of the key 527 alone may cause a “1” to be input.

In addition to keys traditionally associated with an alphanumeric keypad, the keyboard 502 also includes other special function keys, such as an establish call key 530 that causes a received call to be answered or a new call to be originated; a terminate call key 531 that causes the termination of an active call; a drop down menu key 532 that causes a menu to appear within the display 501; a backwards navigation key 534 that causes a previously accessed network address to be accessed again; a favorites key 535 that causes an active web page to be placed in a bookmarks folder of favorite sites, or causes a bookmarks folder to appear; a home page key 536 that causes an application invoked on the device 500 to navigate to a predetermined network address; or other keys that provide for multiple-way navigation, application selection, and power and volume control.

The user uses the pointing device 504 to select and adjust graphics and text objects displayed on the display 501 as part of the interaction with and control of the device 500 and the applications invoked on the device 500. The pointing device 504 is any appropriate type of pointing device, and may be a joystick, a trackball, a touch-pad, a camera, a voice input device, a touch screen device implemented in combination with the display 501, or any other input device.

The antenna 505, which can be an external antenna or an internal antenna, is a directional or omni-directional antenna used for the transmission and reception of radiofrequency (RF) signals that implement point-to-point radio communication, wireless local area network (LAN) communication, or location determination. The antenna 505 may facilitate point-to-point radio communication using the Specialized Mobile Radio (SMR), cellular, or Personal Communication Service (PCS) frequency bands, and may implement the transmission of data using any number or data standards. For example, the antenna 505 may allow data to be transmitted between the device 500 and a base station using technologies such as Wireless Broadband (WiBro), Worldwide Interoperability for Microwave ACCess (WiMAX), 5GPP Long Term Evolution (LTE), Ultra Mobile Broadband (UMB), High Performance Radio Metropolitan Network (HIPERMAN), iBurst or High Capacity Spatial Division Multiple Access (HC-SDMA), High Speed OFDM Packet Access (HSOPA), High-Speed Packet Access (HSPA), HSPA Evolution, HSPA+, High Speed Upload Packet Access (HSUPA), High Speed Downlink Packet Access (HSDPA), Generic Access Network (GAN), Time Division-Synchronous Code Division Multiple Access (TD-SCDMA), Evolution-Data Optimized (or Evolution-Data Only) (EVDO), Time Division-Code Division Multiple Access (TD-CDMA), Freedom Of Mobile Multimedia Access (FOMA), Universal Mobile Telecommunications System (UMTS), Wideband Code Division Multiple Access (W-CDMA), Enhanced Data rates for GSM Evolution (EDGE), Enhanced GPRS (EGPRS), Code Division Multiple Access-2000 (CDMA2000), Wideband Integrated Dispatch Enhanced Network (WiDEN), High-Speed Circuit-Switched Data (HSCSD), General Packet Radio Service (GPRS), Personal Handy-Phone System (PHS), Circuit Switched Data (CSD), Personal Digital Cellular (PDC), CDMAone, Digital Advanced Mobile Phone System (D-AMPS), Integrated Digital Enhanced Network (IDEN), Global System for Mobile communications (GSM), DataTAC, Mobitex, Cellular Digital Packet Data (CDPD), Hicap, Advanced Mobile Phone System (AMPS), Nordic Mobile Phone (NMP), Autoradiopuhelin (ARP), Autotel or Public Automated Land Mobile (PALM), Mobiltelefonisystem D (MTD), Offentlig Landmobil Telefoni (OLT), Advanced Mobile Telephone System (AMTS), Improved Mobile Telephone Service (IMTS), Mobile Telephone System (MTS), Push-To-Talk (PTT), or other technologies. Communication via W-CDMA, HSUPA, GSM, GPRS, and EDGE networks may occur, for example, using a QUALCOMM MSM7200A chipset with an QUALCOMM RTR6285™ transceiver and PM7540™ power management circuit.

The wireless or wireline computer network connection 506 may be a modem connection, a local-area network (LAN) connection including the Ethernet, or a broadband wide-area network (WAN) connection such as a digital subscriber line (DSL), cable high-speed internet connection, dial-up connection, T-1 line, T-3 line, fiber optic connection, or satellite connection. The network connection 506 may connect to a LAN network, a corporate or government WAN network, the Internet, a telephone network, or other network. The network connection 506 uses a wireline or wireless connector. Example wireless connectors include, for example, an INFRARED DATA ASSOCIATION (IrDA) wireless connector, a Wi-Fi wireless connector, an optical wireless connector, an INSTITUTE OF ELECTRICAL AND ELECTRONICS ENGINEERS (IEEE) Standard 802.11 wireless connector, a BLUETOOTH wireless connector (such as a BLUETOOTH version 1.2 or 5.0 connector), a near field communications (NFC) connector, an orthogonal frequency division multiplexing (OFDM) ultra wide band (UWB) wireless connector, a time-modulated ultra wide band (TM-UWB) wireless connector, or other wireless connector. Example wireline connectors include, for example, a IEEE-1394 FIREWIRE connector, a Universal Serial Bus (USB) connector (including a mini-B USB interface connector), a serial port connector, a parallel port connector, or other wireline connector. In another implementation, the functions of the network connection 506 and the antenna 505 are integrated into a single component.

The camera 507 allows the device 500 to capture digital images, and may be a scanner, a digital still camera, a digital video camera, other digital input device. In one example implementation, the camera 507 is a 5 mega-pixel (MP) camera that utilizes a complementary metal-oxide semiconductor (CMOS).

The microphone 509 allows the device 500 to capture sound, and may be an omni-directional microphone, an unidirectional microphone, a bi-directional microphone, a shotgun microphone, or other type apparatus that converts sound to an electrical signal. The microphone 509 may be used to capture sound generated by a user, for example when the user is speaking to another user during a telephone call via the device 500. Conversely, the speaker 510 allows the device to convert an electrical signal into sound, such as a voice from another user generated by a telephone application program, or a ring tone generated from a ring tone application program. Furthermore, although the device 500 is illustrated in FIG. 5 as a handheld device, in further implementations the device 500 may be a laptop, a workstation, a midrange computer, a mainframe, an embedded system, telephone, desktop PC, a tablet computer, a PDA, or other type of computing device.

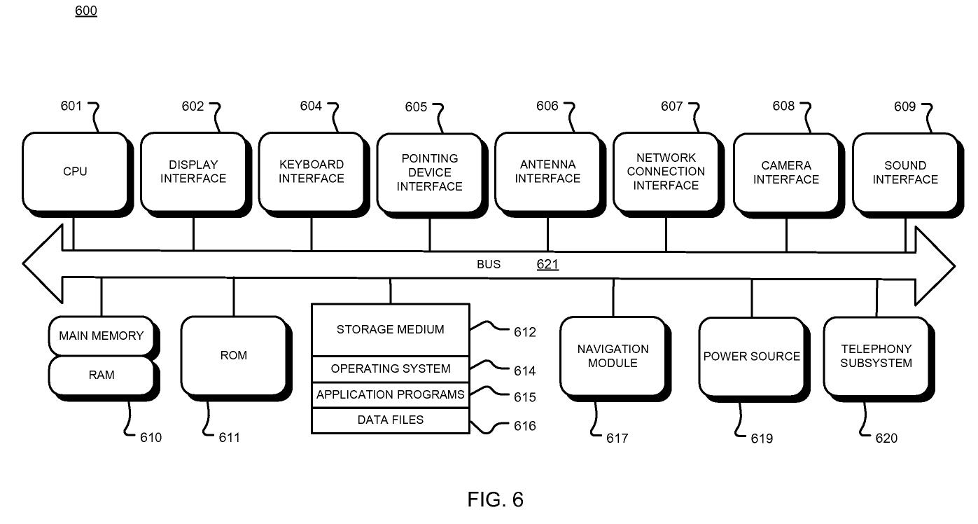

FIG. 6 is a block diagram illustrating an internal architecture 600 of the device 500. The architecture includes a central processing unit (CPU) 601 where the computer instructions that comprise an operating system or an application are processed; a display interface 602 that provides a communication interface and processing functions for rendering video, graphics, images, and texts on the display 501, provides a set of built-in controls (such as buttons, text and lists), and supports diverse screen sizes; a keyboard interface 604 that provides a communication interface to the keyboard 502; a pointing device interface 605 that provides a communication interface to the pointing device 504; an antenna interface 606 that provides a communication interface to the antenna 505; a network connection interface 607 that provides a communication interface to a network over the computer network connection 506; a camera interface 609 that provides a communication interface and processing functions for capturing digital images from the camera 507; a sound interface that provides a communication interface for converting sound into electrical signals using the microphone 509 and for converting electrical signals into sound using the speaker 510; a random access memory (RAM) 610 where computer instructions and data are stored in a volatile memory device for processing by the CPU 601; a read-only memory (ROM) 611 where invariant low-level systems code or data for basic system functions such as basic input and output (I/O), startup, or reception of keystrokes from the keyboard 502 are stored in a non-volatile memory device; a storage medium 612 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files that comprise an operating system 613, application programs 615 (including, for example, a web browser application, a widget or gadget engine, and or other applications, as necessary) and data files 619 are stored; a navigation module 617 that provides a real-world or relative position or geographic location of the device 500; a power source 619 that provides an appropriate alternating current (AC) or direct current (DC) to power components; and a telephony subsystem 620 that allows the device 500 to transmit and receive sound over a telephone network. The constituent devices and the CPU 601 communicate with each other over a bus 621.

The CPU 601 can be one of a number of computer processors. In one arrangement, the computer CPU 601 is more than one processing unit. The RAM 610 interfaces with the computer bus 621 so as to provide quick RAM storage to the CPU 601 during the execution of software programs such as the operating system application programs, and device drivers. More specifically, the CPU 601 loads computer-executable process steps from the storage medium 612 or other media into a field of the RAM 610 in order to execute software programs. Data is stored in the RAM 610, where the data is accessed by the computer CPU 601 during execution. In one example configuration, the device 500 includes at least 128 MB of RAM, and 256 MB of flash memory.

The storage medium 612 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 500 to access computer-executable process steps, application programs and the like, stored on removable and non-removable memory media, to off-load data from the device 500, or to upload data onto the device 500.

A computer program product is tangibly embodied in storage medium 612, a machine-readable storage medium. The computer program product includes instructions that, when read by a machine, operate to cause a data processing apparatus to store image data in the mobile device. In some embodiments, the computer program product includes instructions that generate a social disambiguation dictionary.

The operating system 613 may be a LINUX-based operating system such as the GOOGLE mobile device platform; APPLE MAC OS X; MICROSOFT WINDOWS NT/WINDOWS 2000/WINDOWS XP/WINDOWS MOBILE; a variety of UNIX-flavored operating systems; or a proprietary operating system for computers or embedded systems. The application development platform or framework for the operating system 613 may be: BINARY RUNTIME ENVIRONMENT FOR WIRELESS (BREW); JAVA Platform, Micro Edition (JAVA ME) or JAVA 2 Platform, Micro Edition (J2ME) using the SUN MICROSYSTEMS JAVASCRIPT programming language; PYTHON™, FLASH LITE, or MICROSOFT.NET Compact, or another appropriate environment.

The device stores computer-executable code for the operating system 613, and the application programs 615 such as an email, instant messaging, a video service application, a mapping application word processing, spreadsheet, presentation, gaming, mapping, web browsing, JAVASCRIPT engine, or other applications. For example, one implementation may allow a user to access the GOOGLE GMAIL email application, the GOOGLE TALK instant messaging application, a YOUTUBE video service application, a GOOGLE MAPS or GOOGLE EARTH mapping application, or a GOOGLE PICASA imaging editing and presentation application. The application programs 615 may also include a widget or gadget engine, such as a TAFRI widget engine, a MICROSOFT gadget engine such as the WINDOWS SIDEBAR gadget engine or the KAPSULES gadget engine, a YAHOO! widget engine such as the KONFABULTOR widget engine, the APPLE DASHBOARD widget engine, the GOOGLE gadget engine, the KLIPFOLIO widget engine, an OPERA widget engine, the WIDSETS widget engine, a proprietary widget or gadget engine, or other widget or gadget engine the provides host system software for a physically-inspired applet on a desktop.

Although it is possible to provide for the social disambiguation dictionary using the above-described implementation, it is also possible to implement the functions according to the present disclosure as a dynamic link library (DLL), or as a plug-in to other application programs such as an Internet web-browser such as the FOXFIRE web browser, the APPLE SAFARI web browser or the MICROSOFT INTERNET EXPLORER web browser.

The navigation module 621 may determine an absolute or relative position of the device, such as by using the Global Positioning System (GPS) signals, the GLObal NAvigation Satellite System (GLONASS), the Galileo positioning system, the Beidou Satellite Navigation and Positioning System, an inertial navigation system, a dead reckoning system, or by accessing address, internet protocol (IP) address, or location information in a database. The navigation module 621 may also be used to measure angular displacement, orientation, or velocity of the device 500, such as by using one or more accelerometers.

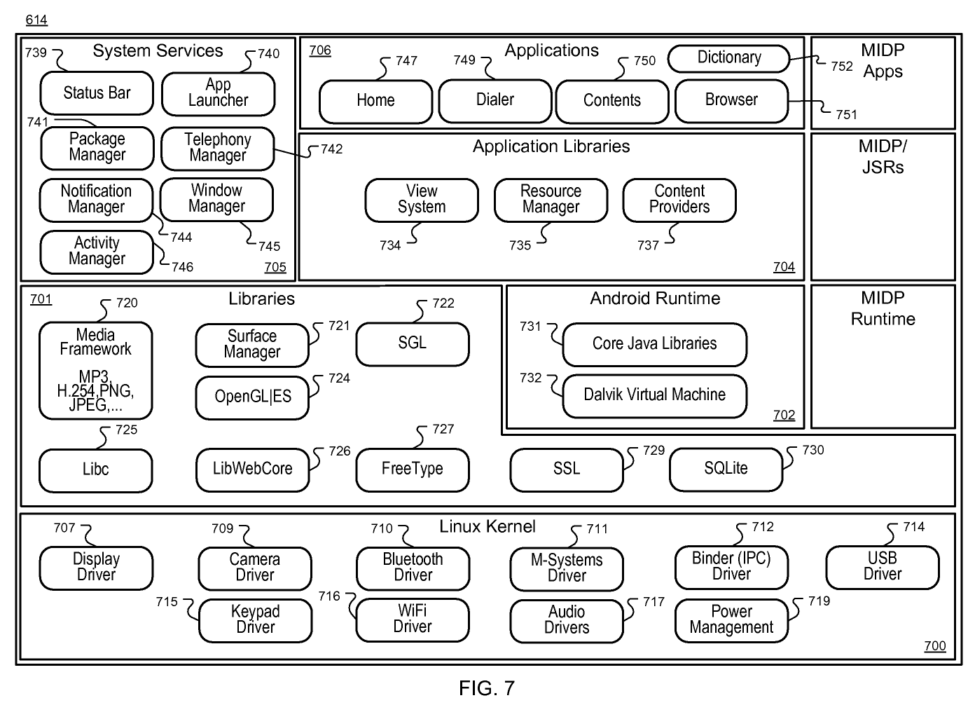

FIG. 7 is a block diagram illustrating exemplary components of the operating system 713 used by the device 700, in the case where the operating system 713 is the GOOGLE mobile device platform. The operating system 713 invokes multiple processes, while ensuring that the associated phone application is responsive, and that wayward applications do not cause a fault (or “crash”) of the operating system. Using task switching, the operating system 713 allows for the switching of applications while on a telephone call, without losing the state of each associated application. The operating system 713 may use an application framework to encourage reuse of components, and provide a scalable user experience by combining pointing device and keyboard inputs and by allowing for pivoting. Thus, the operating system can provide a rich graphics system and media experience, while using an advanced, standards-based web browser.

The operating system 713 can generally be organized into six components: a kernel 700, libraries 701, an operating system runtime 702, application libraries 704, system services 705, and applications 706. The kernel 700 includes a display driver 707 that allows software such as the operating system 713 and the application programs 715 to interact with the display 501 via the display interface 702, a camera driver 709 that allows the software to interact with the camera 507; a BLUETOOTH driver 710; a M-Systems driver 711; a binder (IPC) driver 712, a USB driver 714 a keypad driver 715 that allows the software to interact with the keyboard 502 via the keyboard interface 704; a WiFi driver 716; audio drivers 717 that allow the software to interact with the microphone 509 and the speaker 510 via the sound interface 709; and a power management component 719 that allows the software to interact with and manage the power source 719.

The BLUETOOTH driver, which in one implementation is based on the BlueZ BLUETOOTH stack for LINUX-based operating systems, provides profile support for headsets and hands-free devices, dial-up networking, personal area networking (PAN), or audio streaming (such as by Advance Audio Distribution Profile (A2DP) or Audio/Video Remote Control Profile (AVRCP). The BLUETOOTH driver provides JAVA bindings for scanning, pairing and unpairing, and service queries.

The libraries 701 include a media framework 720 that supports standard video, audio and still-frame formats (such as Moving Picture Experts Group (MPEG)-4, H.264, MPEG-1 Audio Layer-3 (MP3), Advanced Audio Coding (AAC), Adaptive Multi-Rate (AMR), Joing Photographic Experts Group (JPEG), and others) using an efficient JAVA Application Programming Interface (API) layer; a surface manager 721; a simple graphics library (SGL) 722 for two-dimensional application drawing; an Open Graphics Library for Embedded Systems (OpenGL ES) 724 for gaming and three-dimensional rendering; a C standard library (LIBC) 725; a LIBWEBCORE library 726; a FreeType library 727; an SSL 729; and an SQLite library 730.

The operating system runtime 702, which generally makes up a Mobile Information Device Profile (MIDP) runtime, includes core JAVA libraries 731, and a Dalvik virtual machine 732. With regard to graphics rendering, a system-wide composer manages surfaces and a frame buffer and handles window transitions, using the OpenGL ES 724 and two-dimensional hardware accelerators for its compositions.

The Dalvik virtual machine 732 may be used with an embedded environment, since it uses runtime memory very efficiently, implements a CPU-optimized bytecode interpreter, and supports multiple virtual machine processes per device. The custom file format (.DEX) is designed for runtime efficiency, using a shared constant pool to reduce memory, read-only structures to improve cross-process sharing, concise, and fixed-width instructions to reduce parse time, thereby allowing installed applications to be translated into the custom file formal at build-time. The associated bytecodes are designed for quick interpretation, since register-based instead of stack-based instructions reduce memory and dispatch overhead, since using fixed width instructions simplifies parsing, and since the 16-bit code units minimize reads.

The application libraries 704 includes a view system 734, a resource manager 735, and content providers 737. The system services 705 includes a status bar 739; an application launcher 740; a package manager 741 that maintains information for all installed applications; a telephony manager 742 that provides an application level JAVA interface to the telephony subsystem 720; a notification manager 744 that allows all applications access to the status bar and on-screen notifications; a window manager 745 that allows multiple applications with multiple windows to share the display 501; and an activity manager 746 that runs each application in a separate process, manages an application life cycle, and maintains a cross-application history.

The applications 706, which generally make up the MIDP applications, include a home application 747, a dialer application 749, a contacts application 750, a browser application 751, and a social disambiguation dictionary application 752.

The telephony manager 742 provides event notifications (such as phone state, network state, Subscriber Identity Module (SIM) status, or voicemail status), allows access to state information (such as network information, SIM information, or voicemail presence), initiates calls, and queries and controls the call state. The browser application 751 renders web pages in a full, desktop-like manager, including navigation functions. Furthermore, the browser application 751 allows single column, small screen rendering, and provides for the embedding of HTML views into other applications.

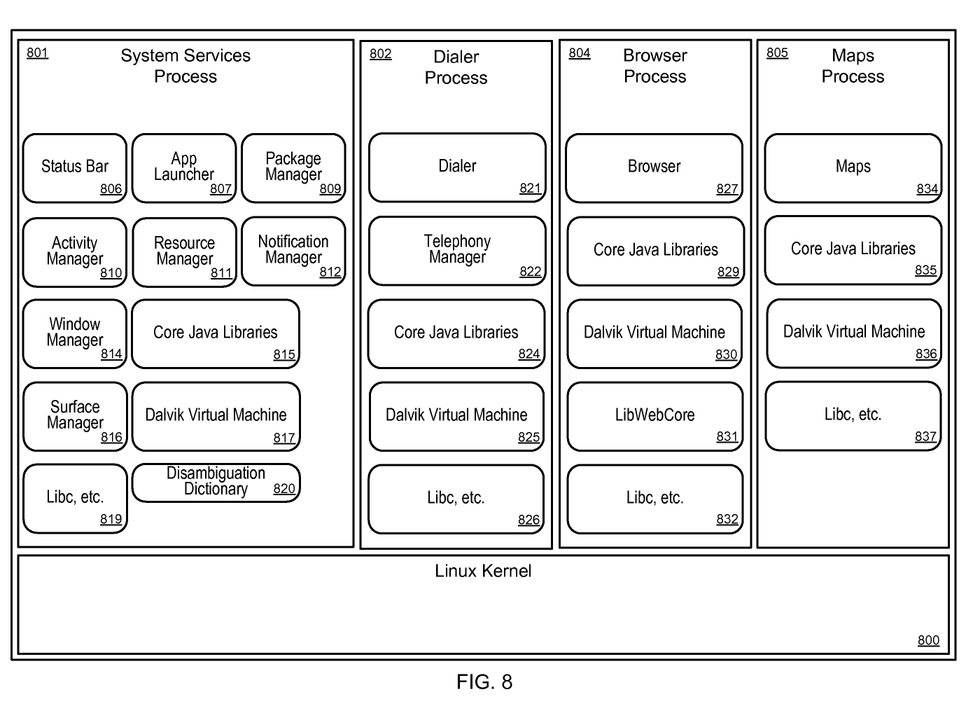

FIG. 8 is a block diagram illustrating exemplary processes implemented by the operating system kernel 514. Generally, applications and system services run in separate processes, where the activity manager 746 runs each application in a separate process and manages the application life cycle. The applications run in their own processes, although many activities or services can also run in the same process. Processes are started and stopped as needed to run an application's components, and processes may be terminated to reclaim resources. Each application is assigned its own process, whose name is the application's package name, and individual parts of an application can be assigned another process name.

The persistent core system services, such as the surface manager 816, the window manager 814, or the activity manager 810, are hosted by system processes, although application processes, such processes associated with the dialer application 821, may also be persistent. The processes implemented by the operating system kernel 514 may generally be categorized as system services processes 801, dialer processes 802, browser processes 804, and maps processes 805. The system services processes 801 include status bar processes 806 associated with the status bar 739; application launcher processes 807 associated with the application launcher 740; package manager processes 809 associated with the package manager 741; activity manager processes 810 associated with the activity manager 746; resource manager processes 811 associated with a resource manager that provides access to graphics, localized strings, and XML layout descriptions; notification manger processes 812 associated with the notification manager 744; window manager processes 814 associated with the window manager 745; core JAVA libraries processes 815 associated with the core JAVA libraries 731; surface manager processes 816 associated with the surface manager 721; Dalvik virtual machine processes 817 associated with the Dalvik virtual machine 732, LIBC processes 819 associated with the LIBC library 725; and social disambiguation dictionary processes 720 associated with the social disambiguation dictionary application 752.

The dialer processes 802 include dialer application processes 821 associated with the dialer application 749; telephony manager processes 822 associated with the telephony manager 742; core JAVA libraries processes 824 associated with the core JAVA libraries 731; Dalvik virtual machine processes 825 associated with the Dalvik Virtual machine 732; and LIBC processes 826 associated with the LIBC library 725. The browser processes 804 include browser application processes 827 associated with the browser application 751; core JAVA libraries processes 829 associated with the core JAVA libraries 731; Dalvik virtual machine processes 830 associated with the Dalvik virtual machine 732; LIBWEBCORE processes 831 associated with the LIBWEBCORE library 726; and LIBC processes 832 associated with the LIBC library 725.

The maps processes 805 include maps application processes 834, core JAVA libraries processes 835, Dalvik virtual machine processes 836, and LIBC processes 837. Notably, some processes, such as the Dalvik virtual machine processes, may exist within one or more of the systems services processes 801, the dialer processes 802, the browser processes 804, and the maps processes 805.

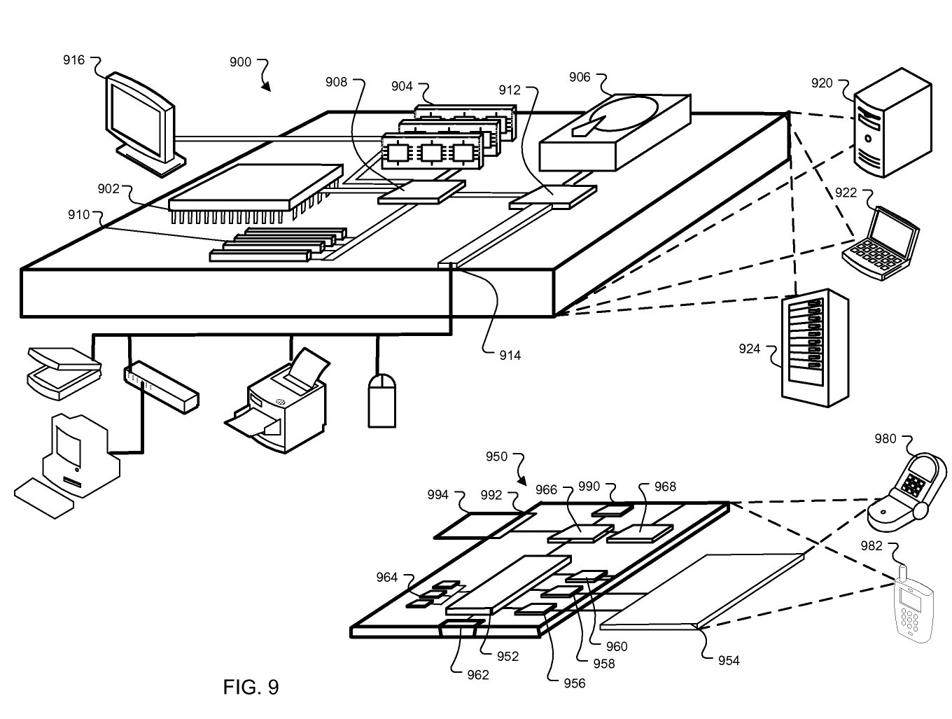

FIG. 9 shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, memory on processor 902, or a propagated signal.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, the social disambiguation dictionary can be used for word completion within a variety of applications. In addition, the usage data for socially-related individuals may be used for purposes other than, or in addition to, disambiguation of entered data. Accordingly, other embodiments are within the scope of the following claims.

What is claimed is:

1. A computer-implemented method, comprising:
receiving a request to provide a dictionary for a computing device associated with a user;
identifying word usage information for members of a social network for the user; and
generating, with the word usage information for the members of the social network, a dictionary for the user.

2. The method of claim 1, wherein the received request to provide the dictionary comprises an express user request for a customized disambiguation dictionary.

3. The method of claim 2, further comprising weighting the word usage information against a standard language dictionary.

4. The method of claim 1, wherein identifying the word usage information for the members of the social network comprises identifying the members connected with the user in the social network and analyzing word usage in documents generated by the identified members.

5. The method of claim 1, wherein identifying the word usage information for the members of the social network comprises transmitting the request for dictionary data to a social networking system.

6. The method of claim 1, wherein identifying the word usage information for the members of the social network comprises applying weighting information to words used by the members of the social network.

7. The method of claim 6, wherein the weightings decrease with increasing distance away from the user in the social network.

8. The method of claim 1, wherein generating the dictionary for the user comprises providing updated information for an existing dictionary.

9. The method of claim 1, further comprising receiving ambiguous textual input from the user, and using the dictionary to provide a ranked list of suggested terms that match the ambiguous textual input.

10. The method of claim 9, wherein the textual input is ambiguous because it is entered on keys that are each associated with multiple characters.

11. The method of claim 9, wherein the textual input is ambiguous because the user has not completed entry of a term.

12. The method of claim 1, further comprising periodically identifying the word usage information for the members of the social network and generating updating information for the dictionary.

13. A recordable storage medium having recorded and stored thereon instructions that, when executed, perform actions including:
receiving a request to provide a dictionary for a computing device associated with a user;
identifying word usage information for members of a social network for the user; and
generating, with the word usage information for the members of the social network, a dictionary for the user.

14. The recordable storage medium of claim 13, wherein identifying the word usage information for members of the social network comprises identifying members connected with the user in the social network and analyzing word usage in documents generated by the identified members.

15. The recordable storage medium of claim 13, wherein identifying word usage information for members of the social network comprises applying weighting information to words used by the members of the social network, wherein weightings generated with the weighting information decrease with increasing distance away from the user in the social network.

16. The recordable storage medium of claim 13, wherein the medium further stores instructions that, when executed, further perform the action of using the dictionary to provide a ranked list of suggested terms that match ambiguous textual input received from the user.

17. The recordable storage medium of claim 13, further comprising sending the dictionary to a client device for storage.

18. A computer-implemented textual disambiguation system, comprising:
a social network interface for producing data reflecting the word usage by members of a social network associated with a user;
a dictionary builder programmed to use the data reflecting the word usage of the members of the social network to produce dictionary data formatted for use in disambiguating text input by the user; and
a prediction module programmed to use the dictionary data to disambiguate the text input by the user.

19. The system of claim 18, wherein the data reflecting word usage by members of the social network weights usage by a member inversely to a distance between the member and the user in the social network.

20. A computer-implemented system, comprising:
a social network interface to produce data reflecting word usage by members of a user's social network, using an identifier for the user;
memory storing master dictionary data that reflects general word usage that is not specific to the user; and
means for processing the user usage data into dictionary data for use with the master dictionary to disambiguate textual input by the user.

21. The system of claim 20, further comprising means for disambiguating keystrokes entered by the user on a computing device.
